(19) United States
(12) Patent Application Publication
(10) Pub. No.: US 2024/0342972 A1
(43) Pub. Date: Oct. 17, 2024

(54) INJECTION MOLDING MACHINE PASS/FAIL DETERMINATION SYSTEM

(71) Applicant: Shibaura Machine Co., Ltd., Tokyo (JP)

(72) Inventor: Jun Enomoto, Numazu-shi, Shizuoka (JP)

(73) Assignee: Shibaura Machine Co., Ltd., Tokyo (JP)

(21) Appl. No.: 18/580,051

(22) PCT Filed: Jul. 15, 2022
(86) PCT No.: PCT/JP2022/027867

§ 371 Date: Jan. 17, 2024

(30) Foreign Application Priority Data
Jul. 21, 2021 (JP) 2021-120631

(51) Int. Cl. B29C 45/76

(52) U.S. Cl. CPC B29C 45/768; B29C 2045/7606

(57) ABSTRACT

An injection molding machine pass/fail determination system includes: a monitoring data extraction module that extracts non-defective article monitoring data and defective article monitoring data from basic data in which a pass/fail determination result on a molded article formed by an injection molding machine is associated with monitoring data; a high-influence monitoring data extraction module that extracts high-influence monitoring data having a high influence on a defect type from among the extracted monitoring data; a molding parameter calculation module that calculates a molding parameter being a parameter to be used when pass/fail determination of the molded article during molding performed by the injection molding machine is performed based on the monitoring data of the same type as the high-influence monitoring data; and a pass/fail determination module that compares the molding parameter with a determination threshold being a threshold for the molding parameter and determines whether a defective article has occurred.

### TECHNICAL FIELD

This disclosure relates to a pass/fail determination system used for an injection molding machine that injects a molten resin material to form a molded article.

### BACKGROUND

Functions of monitoring the quality of a molded article formed by an injection molding machine include a function of determining the quality of the molded article by setting an allowable value for each monitoring data such as pressure and temperature obtained from sensors for each shot and comparing the acquired monitoring data with the allowable value. For example, when the barrel temperature deviates from the allowable value set for the reference, the molded article formed by the shot is determined as a defective article.

However, such allowable value setting requires a certain degree of experience on a worker. For this reason, some of pass/fail determination methods in the conventional injection molding machine uses a method capable of easily and reliably performing adjustment to a good state without a burden on a skilled worker. For example, a pass/fail determination method in a plasticizing step in an injection molding machine described in JP 2008-246734 A obtains an MD value based on a reference data value aggregated from data of a parameter related to behavior of a molding material at the time of performing a predetermined shot and a data value aggregated from data of a parameter at the time of a certain shot, and makes a pass/fail determination of an operation in the plasticizing step based on the magnitude of the obtained MD value.

Parameters used in the molding performed by an injection molding machine may cause an interaction with the molded article. However, appropriately determining a defect due to the interaction might be difficult when the pass/fail determination of the molded article is performed based on individual parameters. In addition, when a defect occurs due to an interaction of parameters in the molding performed by the injection molding machine, it is difficult to specify the factor of the defect, leading to a possibility of difficulty in performing adjustment for preventing occurrence of defects. Therefore, there is room for improvement in pass/fail determination in the molding performed by the injection molding machine from the viewpoint of improvement in determination accuracy and capability of specifying a cause of a defect.

It could therefore be helpful to provide an injection molding machine pass/fail determination system that is capable of improving accuracy of pass/fail determination and more reliably specifying a cause of a defect.

### SUMMARY

I thus provide:

an injection molding machine pass/fail determination system including: a monitoring data extraction module configured to extract, from basic data in which a determination result as to whether a molded article formed by an injection molding machine is a non-defective article or a defective article is associated with monitoring data of the injection molding machine at a time of forming the molded article, a plurality of pieces of non-defective article monitoring data and a plurality of pieces of defective article monitoring data, the plurality of pieces of non-defective article monitoring data being the monitoring data at a time of forming the non-defective article, and the plurality of pieces of defective article monitoring data being the monitoring data at a time of forming the defective article; a high-influence monitoring data extraction module configured to extract a plurality of pieces of the monitoring data as high-influence monitoring data in descending order of influence on a defect type of the defective article among the plurality of pieces of the monitoring data extracted by the monitoring data extraction module; a molding parameter calculation module configured to calculate a molding parameter, the molding parameter being a parameter to be used when pass/fail determination of the molded article during molding performed by the injection molding machine is performed based on the monitoring data of a same type as the high-influence monitoring data; and a pass/fail determination module configured to compare the molding parameter calculated by the molding parameter calculation module with a determination threshold being a threshold for the molding parameter, and determine whether the defective article has occurred in the molded article formed by the injection molding machine.

My injection molding machine pass/fail determination system has an effect of improving accuracy of pass/fail determination and more reliably specifying a cause of a defect.

### BRIEF DESCRIPTION OF THE DRAWINGS

FIG. 1 is a schematic diagram illustrating a configuration example of a pass/fail determination system of an injection molding machine according to an example.

FIG. 2 is a diagram of the control device illustrated in FIG. 1.

FIG. 3 is a diagram illustrating a monitoring data determination screen.

FIG. 4 is a flowchart illustrating a flow of control at determination control as to whether monitoring data satisfies a predetermined value.

FIG. 5 is a flowchart illustrating a procedure of generating basic data.

FIG. 6 is a flowchart illustrating a procedure of setting a parameter used in pass/fail determination of a molded article.

FIG. 7 is a schematic diagram of a pass/fail determination setting main screen used at setting of a parameter for pass/fail determination.

FIG. 8 is a schematic diagram of a pass/fail determination setting sub-screen.

FIG. 9 is a diagram illustrating grouping of monitoring data.

FIG. 10 is a diagram illustrating a pass/fail determination screen.

FIG. 11 is a flowchart illustrating a flow of control when control is performed to determine whether a defective article has occurred in a molded article based on monitoring data.

### EXPLANATIONS OF LETTERS OR NUMERALS

1 INJECTION MOLDING MACHINE
2 FRAME
10 INJECTION DEVICE
11 HEATING BARREL
12 NOZZLE
13 SCREW
15 HOPPER
20 WEIGHING UNIT
25 INJECTION DEVICE DRIVE UNIT
30 MOLD CLAMPING DEVICE
31 STATIONARY PLATEN
32 MOVABLE PLATEN
35 STATIONARY MOLD
36 MOVABLE MOLD
40 MOLD CLAMPING DRIVE MECHANISM
41 TOGGLE MECHANISM
45 EXTRUSION MECHANISM
46 EXTRUSION MEMBER
50 MONITORING DATA DETERMINATION SCREEN
51 MONITORING DATA ITEM NAME DISPLAY SECTION
52 REFERENCE VALUE INPUT SECTION
53 ALLOWABLE VALUE INPUT SECTION
54 ALARM SELECTOR
60 PASS/FAIL DETERMINATION SETTING MAIN SCREEN
61 DEFECT NAME INPUT SECTION
62 SETTING BUTTON
70 PASS/FAIL DETERMINATION SETTING SUB-SCREEN
71 DEFECT INFORMATION DISPLAY SECTION
72 EXTRACTION PERIOD INPUT SECTION
73 PASS/FAIL DETERMINATION DATA DISPLAY SECTION
74 SAMPLE SHOT NUMBER DISPLAY SECTION
75 DEFECTIVE article PARAMETER DISPLAY SECTION
76 DETERMINATION PARAMETER HISTOGRAM DISPLAY SECTION
77 DETERMINATION BASIS RECOMMENDED VALUE DISPLAY SECTION
80 PASS/FAIL DETERMINATION SCREEN
81 DEFECT NAME DISPLAY SECTION
82 DETERMINATION THRESHOLD INPUT SECTION
83 ALARM SELECTOR
100 CONTROL DEVICE
110 PROCESSING UNIT
111 MONITORING DATA ACQUISITION MODULE
112 REFERENCE VALUE ACQUISITION MODULE
113 ALLOWABLE VALUE ACQUISITION MODULE
114 MONITORING DATA DETERMINATION MODULE
121 BASIC DATA GENERATION MODULE
122 MONITORING DATA EXTRACTION MODULE
123 HIGH-INFLUENCE MONITORING DATA EXTRACTION MODULE
124 DETERMINATION PARAMETER CALCULATION MODULE
125 MOLDING PARAMETER CALCULATION MODULE
126 RECOMMENDED VALUE CALCULATION MODULE
127 PASS/FAIL DETERMINATION MODULE
128 ABNORMAL DATA EXTRACTION MODULE
140 STORAGE UNIT
150 INPUT/OUTPUT UNIT
160 INPUT UNIT
170 DISPLAY UNIT
200 PASS/FAIL DETERMINATION SYSTEM

### DETAILED DESCRIPTION

Hereinafter, an example of a pass/fail determination system of an injection molding machine according to this disclosure will be described in detail with reference to the drawings. Note that this disclosure is not limited by the example. In addition, constituent elements in the following examples include those that can be replaced by those skilled in the art and can be easily conceived, or those that are substantially the same.

### Example

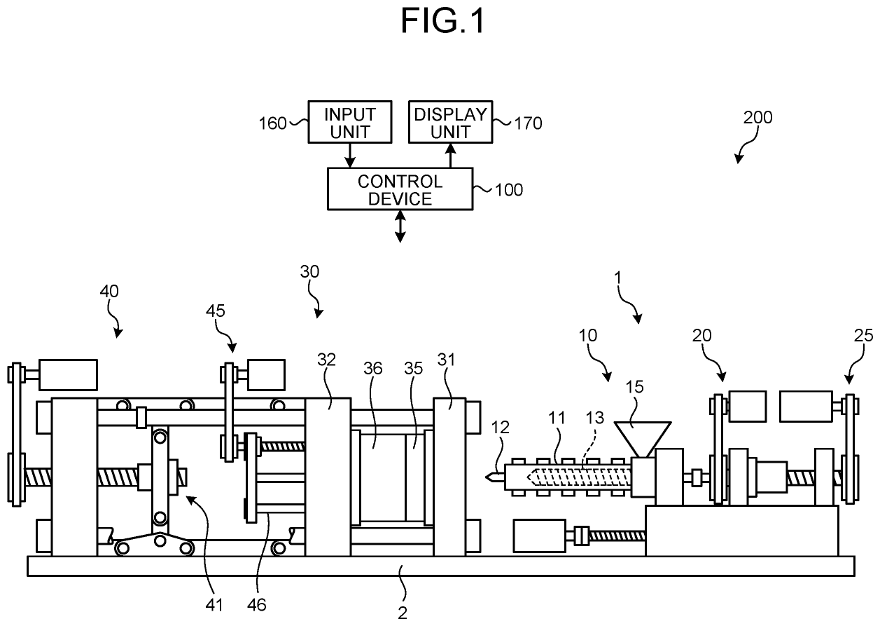

FIG. 1 is a schematic diagram illustrating a configuration example of a pass/fail determination system 200 of an injection molding machine 1 according to an example. In the following description, the vertical direction in the normal use state of the injection molding machine 1 will be also described as the vertical direction in the injection molding machine 1, while the horizontal direction in the normal use state of the injection molding machine 1 will be also described as the horizontal direction in the injection molding machine 1.

### Injection Molding Machine 1

The injection molding machine 1 according to this example includes an injection device 10 and a mold clamping device 30. The injection device 10 and the mold clamping device 30 are disposed on a frame 2 located at a lower end of the injection molding machine 1. The injection molding machine 1 melts a molding material into a plasticizing material by the injection device 10, and cools and solidifies the plasticizing material injected from the injection device 10 by the mold clamping device 30, making it possible to manufacture various types of desired molded articles.

The injection device 10 includes a heating barrel 11, a screw 13, a weighing unit 20, and an injection device drive unit 25. The heating barrel 11 is capable of internally heating and melting the molding material into a plasticizing material. In addition, the heating barrel 11 includes, on its one end side, a nozzle 12 to inject a plasticizing material, and is connected, on the other end side, to a hopper 15 for raw material charging. The screw 13 is disposed in the heating barrel 11 and is movable in the axial direction inside the heating barrel 11.

The weighing unit 20 rotates the screw 13 in the heating barrel 11 to enable introduction of a resin as a molding material into the heating barrel 11 from the hopper 15.

The injection device drive unit 25 can move the screw 13 in the horizontal direction inside the heating barrel 11. In addition, the injection device drive unit 25 operates, inside the heating barrel 11, to move the screw 13 toward the nozzle 12 in a state where the molten molding material is stored in the end portion side where the nozzle 12 is located, making it possible to extrude the molding material from the nozzle 12. This enables the molding material in the heating barrel 11 to be injected from the nozzle 12.

The mold clamping device 30 includes a stationary platen 31, a movable platen 32, a mold clamping drive mechanism 40, and an extrusion mechanism 45. The stationary platen 31 is disposed on the frame 2 to be fixed to the frame 2. The movable platen 32 is disposed on the frame 2 on the side opposite to the position of the injection device 10 with respect to the stationary platen 31 to be movable with respect to the stationary platen 31. There is provided a stationary mold 35 attached to a surface of the stationary platen 31 on a side where the movable platen 32 is located, and a movable mold 36 is attached to a surface of the movable platen 32 on a side where the stationary platen 31 is located. The movable mold 36 attached to the movable platen 32 faces the stationary mold 35 attached to the stationary platen 31. When the movable platen 32 approaches the stationary platen 31, the movable mold 36 approaches the stationary mold 35 to be assembled with the stationary mold 35.

The mold clamping drive mechanism 40 can move the movable platen 32 relative to the stationary platen 31. By moving the movable platen 32 relative to the stationary platen 31, it is possible to perform mold closing of the movable mold 36 and the stationary mold 35 or mold opening of the movable mold 36 and the stationary mold 35. In this example, the mold clamping drive mechanism 40 includes a mechanism referred to as a toggle mechanism 41, and the movable platen 32 can be moved relative to the stationary platen 31 by the toggle mechanism 41.

The extrusion mechanism 45 includes an extrusion member 46, which extrudes the molded article after molding attached to the inner surface of the movable mold 36, making it possible to remove the molded article after molding from the movable mold 36.

### Control Device 100

The injection molding machine 1 includes: a control device 100 that performs various types of control of the injection molding machine 1; an input unit 160 through which an operator performs input operation to the injection molding machine 1; and a display unit 170 that displays various types of information. The input unit 160 and the display unit 170 are both connected to the control device 100. The input unit 160 transmits information obtained by input operation to the control device 100. In addition, the display unit 170 displays information transmitted from the control device 100. The input unit 160 and the display unit 170 may be configured separately, or may be integrally formed by being configured by a display referred to as a touch panel display.

The control device 100 is connected to devices like various actuators such as a motor to be a power source of the operation in the injection molding machine 1 and various sensors that acquire information during the operation of the injection molding machine 1. With this configuration, the control device 100 can control the injection molding machine 1 by transmitting a control signal to the actuator of the injection molding machine 1 while acquiring information during operation of the injection molding machine 1 by the sensor.

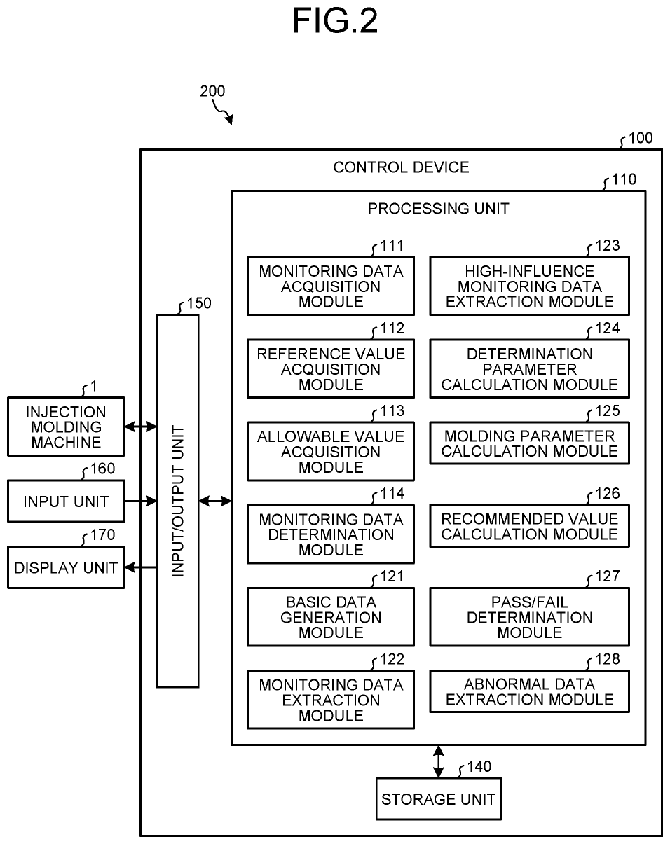

FIG. 2 is a diagram illustrating the control device 100 illustrated in FIG. 1. The control device 100 includes a processing unit 110, a storage unit 140, and an input/output unit 150. The processing unit 110 includes a central processing unit (CPU) that performs arithmetic processing, and devices functioning as memory that stores various types of information such as random access memory (RAM) and read only memory (ROM). All or a part of each function of the processing unit 110 is implemented by loading an application program stored in the ROM into the RAM and executing the program by the CPU to perform data reading and writing on the RAM or the ROM.

The storage unit 140 is a storage device that is electrically connected to the processing unit 110 and stores information. When the control device 100 controls the injection molding machine 1, the information acquired from the injection molding machine 1 by the processing unit 110 and the information calculated by the processing unit 110 are stored in the storage unit 140, or the information stored in the storage unit 140 is retrieved by the processing unit 110 and used for controlling the injection molding machine 1.

Individual functions implemented by the processing unit 110 may be pre-stored in the storage unit 140 as a program. In this example, the processing unit 110 executes individual functions by retrieving a program stored in the storage unit 140 by the processing unit 110 and executing an operation according to the program by the processing unit 110. Furthermore, the storage unit 140 may be provided integrally with the control device 100, or may be detachable from the control device 100.

The input/output unit 150 is a unit functioning as an interface, configured to input and output signals to and from a device outside the control device 100. That is, the input/output unit 150 is connected with various actuators and various sensors of the injection molding machine 1 connected to the control device 100, the input unit 160, and the display unit 170. The processing unit 110 included in the control device 100 transmits and receives signals to and from these external devices via the input/output unit 150.

The processing unit 110 includes, as functional units, a monitoring data acquisition module 111, a reference value acquisition module 112, an allowable value acquisition module 113, a monitoring data determination module 114, a basic data generation module 121, a monitoring data extraction module 122, a high-influence monitoring data extraction module 123, a determination parameter calculation module 124, a molding parameter calculation module 125, a recommended value calculation module 126, a pass/fail determination module 127, and an abnormal data extraction module 128.

Among these units, the monitoring data acquisition module 111 can acquire monitoring data, which is detection results obtained by various sensors included in the injection molding machine 1 when the injection molding machine 1 is in operation. Examples of the monitoring data include the temperature at which the molding material is melted by the heating barrel 11 of the injection device 10 of the injection molding machine 1, the time used for introducing the molding material into the heating barrel 11 and weighing the molding material, and the rotation speed of the screw 13. The monitoring data acquisition module 111 stores the acquired monitoring data in the storage unit 140 together with the time of acquisition. That is, the monitoring data acquisition module 111 stores the acquired monitoring data in the storage unit 140 in association with the date and time of acquisition.

The reference value acquisition module 112 acquires a reference value of monitoring data, related to the time of operation of the injection molding machine 1 and having been input by the user of the injection molding machine 1 using the input unit 160. The reference value acquisition module 112 stores the acquired reference value of the monitoring data in the storage unit 140.

The allowable value acquisition module 113 acquires an allowable value for the reference value of the monitoring data, which is related to the time of operation of the injection molding machine 1 and having been input by the user of the injection molding machine 1 using the input unit 160. The allowable value acquisition module 113 stores the acquired allowable value for the reference value of the monitoring data in the storage unit 140.

The monitoring data determination module 114 compares the monitoring data acquired by the monitoring data acquisition module 111 with the reference value acquired by the reference value acquisition module 112 and the allowable value acquired by the allowable value acquisition module 113, and determines whether the monitoring data is within the range of the allowable value.

The basic data generation module 121 generates basic data in which a determination result as to whether the molded article formed by the injection molding machine 1 is a non-defective article or a defective article is associated with monitoring data of the injection molding machine 1 when the molded article is formed, that is, the monitoring data acquired by the monitoring data acquisition module 111. The basic data generated by the basic data generation module 121 is stored in the storage unit 140 in association with the date and time of acquisition of the monitoring data or the date and time of forming the molded article.

From the basic data generated by the basic data generation module 121, the monitoring data extraction module 122 extracts a plurality of pieces of non-defective article monitoring data which are monitoring data at the time of forming a non-defective article, and a plurality of pieces of defective article monitoring data which are monitoring data at the time of forming a defective article. That is, since the basic data is data in which the determination result of the molded article formed by the injection molding machine 1 is associated with the monitoring data at the time of molding the molded article. Therefore, the non-defective article monitoring data and the defective article monitoring data are distinguished and extracted by the determination results the molded article and the monitoring data at the time of forming of each molded article.

In addition, the monitoring data extraction module 122 extracts the non-defective article monitoring data and the defective article monitoring data of the same type for each defect type of the defective article. That is, the monitoring data extraction module 122 extracts the non-defective article monitoring data and the defective article monitoring data in association with the defect type of the defective article. The non-defective article monitoring data and the defective article monitoring data extracted by the monitoring data extraction module 122 are stored in the storage unit 140.

Examples of the defect type herein include short shot, burr, flow mark, silver streak, jetting, burn, cloudiness, whitening, weld line, warpage, crack, yellowing, sink mark, and void.

The short shot is a defect in a state where the resin is not completely filled. The burr is a defect of occurrence of a surplus portion on the outer periphery of the molded article, caused by the molten material entering the gap of the mold. The flow mark is a defect appearing on the surface of the molded article as a striped pattern caused by the resin flowing in the mold. The silver streak is a defect appearing as a white streak occurring along the flow of the resin starting from a gate portion, which is an opening to a flow path of the resin onto the molded article in the mold.

The jetting is a defect appearing as a trace of the resin flowing after passing through the gate. Burn is a defect as a burnt end portion of the resin. The cloudiness is a defect appearing as a surface that becomes cloudy white particularly in molding of a transparent resin. Whitening is a defect appearing as a locally stretched portion formed by application of an excessive force on a solidified resin. The weld line is a defect occurring as a line-shaped trace appearing at a meeting portion of flow fronts branched by the cavity shape of the mold.

The warpage is a defect appearing as a warped shape of the molded article. Cracks are defects occurring as cracked portions on the surface of the molded article. The yellowing is a defect appearing as a portion on the resin surface that has turned yellow. Sink marks are defects appearing as surface portions recessed due to molding shrinkage. Void is a defect appearing as an internal hollow caused by molding shrinkage.

The high-influence monitoring data extraction module 123 extracts a plurality of pieces of monitoring data in order from the highest influence on the defect type of a defective article among the plurality of pieces of monitoring data extracted by the monitoring data extraction module 122. That is, when molding has been performed by the injection molding machine 1, the operating state of the injection molding machine 1 and the state of the resin during molding will have an influence on the quality of the molded article. Therefore, it is conceivable that the molded article determined to be a defective article has monitoring data that indicates occurrence of deviation from the reference value during forming of the molded article, as a factor of the defect.

For this reason, from among the plurality of pieces of monitoring data extracted by the monitoring data extraction module 122, the high-influence monitoring data extraction module 123 extracts a plurality of pieces of monitoring data having a high influence on the defect type in the molded article determined as the defective article, as high-influence monitoring data for each defect type. The high-influence monitoring data extracted by the high-influence monitoring data extraction module 123 is stored in the storage unit 140 in association with the defect type.

The determination parameter calculation module 124 calculates a determination parameter, which is a parameter used for the pass/fail determination of the molded article formed by the injection molding machine 1 based on the monitoring data extracted by the monitoring data extraction module 122. The determination parameter is a value calculated based on a Mahalanobis distance obtained by applying a known Mahalanobis-Taguchi (MT) method. Specifically, in this example, a value of the square of the Mahalanobis distance (MD value) obtained by applying the MT method is used as the determination parameter. The value being the square of the MD value obtained by applying the MT method to the monitoring data in this manner is referred to as the determination parameter. The determination parameter calculation module 124 calculates the determination parameter for the non-defective article monitoring data in the monitoring data of the non-defective article monitoring data and the defective article monitoring data extracted by the monitoring data extraction module 122, as a non-defective article parameter. In addition, the determination parameter calculation module 124 calculates a determination parameter for the defective article monitoring data in the non-defective article monitoring data and the defective article monitoring data extracted by the monitoring data extraction module 122, as a defective article parameter.

Further, the determination parameter calculation module 124 calculates a non-defective article parameter of the non-defective article monitoring data and a defective article parameter of the defective article monitoring data individually in the high-influence monitoring data extracted by the high-influence monitoring data extraction module 123.

The molding parameter calculation module 125 calculates a molding parameter, which is a parameter when the pass/fail determination of the molded article during molding by the injection molding machine 1 is performed based on the same type of monitoring data as the high-influence monitoring data, acquired by the monitoring data acquisition module 111. The molding parameter is calculated as a determination parameter of the monitoring data acquired by the monitoring data acquisition module 111 at the time of molding by the injection molding machine 1 on the monitoring data extracted by the monitoring data extraction module 122. That is, using the monitoring data of the same type as the high-influence monitoring data and the monitoring data extracted by the monitoring data extraction module 122, which are data during molding by the injection molding machine 1, the molding parameter calculation module 125 calculates, as the molding parameter, the determination parameter obtained by applying the known MT method, similarly to the determination parameter calculation module 124. The molding parameter calculation module 125 that calculates the molding parameter in this manner calculates the molding parameter for each defect type of the defective article in the monitoring data extracted by the monitoring data extraction module 122.

The recommended value calculation module 126 calculates a determination basis recommended value, which is a threshold recommended as a criterion for determination when determining whether a defective article has occurred in the molded article during molding by the injection molding machine 1, based on the non-defective article monitoring data extracted by the monitoring data extraction module 122. The determination basis recommended value calculated by the recommended value calculation module 126 is calculated as a threshold of a determination parameter for monitoring data acquired by the monitoring data acquisition module 111 during molding by the injection molding machine 1 with respect to the monitoring data extracted by the monitoring data extraction module 122.

The pass/fail determination module 127 compares the molding parameter calculated by the molding parameter calculation module 125 with a determination threshold that is a threshold for the molding parameter, and determines whether a defective article has occurred in the molded articles formed by the injection molding machine 1. Regarding the determination threshold used by the pass/fail determination module 127 to determine whether the defective article has occurred in the molded articles, the determination basis recommended value calculated by the recommended value calculation module 126 is to be used as the determination threshold, or a value set by the user based on the determination basis recommended value is to be used as the determination threshold. The pass/fail determination module 127 determines whether a defective article has occurred in the molded articles formed by the injection molding machine 1 for each defect type of the defective article.

When the pass/fail determination module 127 determines that a defective article has occurred in the molded articles during molding by the injection molding machine 1, the abnormal data extraction module 128 extracts monitoring data having the highest abnormality degree among a plurality of pieces of monitoring data of the same type as the defective article monitoring data extracted by the monitoring data extraction module 122. In this example, the abnormal data extraction module 128 extracts, as monitoring data having the highest abnormality degree, monitoring data having a largest deviation from the non-defective article monitoring data in the high-influence monitoring data among a plurality of pieces of monitoring data of the same type as the plurality of pieces of high-influence monitoring data during molding on the injection molding machine 1.

### Operation of Pass/Fail Determination System 200 of Injection Molding Machine 1

The pass/fail determination system 200 of the injection molding machine 1 according to this example includes the above configuration. Now, the operation of the pass/fail determination system 200 will be described below. With one operation of injection/molding defined as one cycle, the injection molding machine 1 repeatedly executes the cycle of injection/molding operation. Each cycle includes a plurality of steps for injection of the molding material and molding of the product. Each cycle includes, for example, a mold closing step, a pressure increasing step, a filling (injection) step, a pressure holding step, a weighing step, a mold opening step, and an extrusion step.

When injection/molding is performed by the injection molding machine 1 using these steps, monitoring data detected by each sensor included in the injection molding machine 1 is acquired by the control device 100, and the injection/molding operation is repeated while monitoring the operation state of the injection molding machine 1 based on the monitoring data. In this example, monitoring of the state of operation of the injection molding machine 1 based on the monitoring data includes two types of determinations: a determination as to whether the monitoring data satisfies a predetermined value; and a determination as to whether a defective article has occurred in molded articles formed by the injection molding machine 1 based on the monitoring data.

### Monitoring Data Determination Screen 50

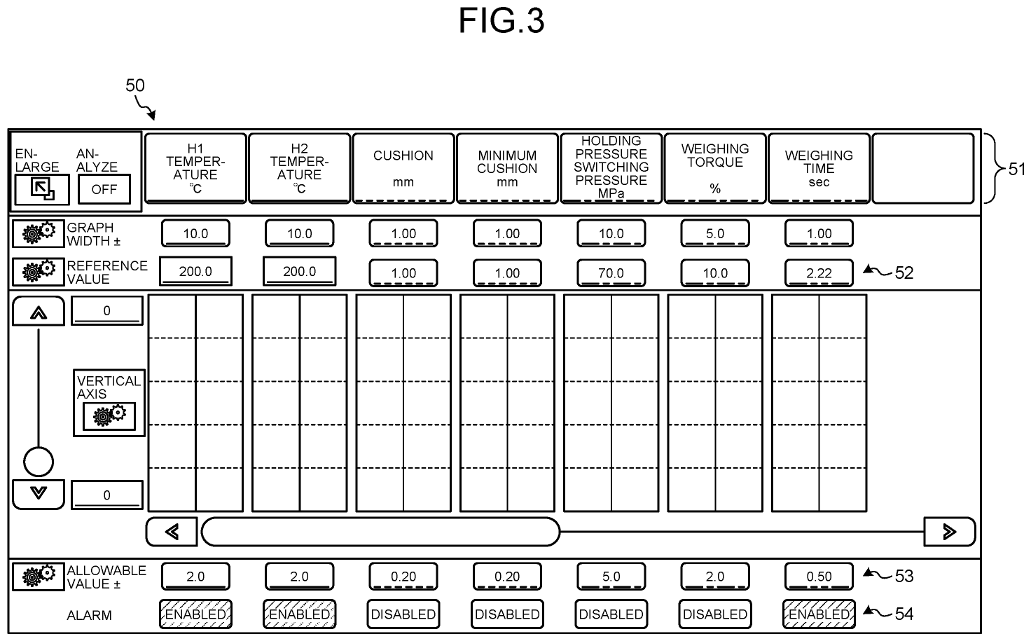

First, the following will describe a monitoring data determination screen 50, which is to be displayed on the display unit 170 and used for controlling the determination as to whether the monitoring data satisfies a predetermined value. FIG. 3 is a diagram illustrating the monitoring data determination screen 50. The control device 100 determines whether the monitoring data satisfies a predetermined value while displaying a monitoring data determination screen 50 as illustrated in FIG. 3 on the display unit 170. The monitoring data determination screen 50 illustrated in FIG. 3 includes a monitoring data item name display section 51, a reference value input section 52, an allowable value input section 53, and an alarm selector 54.

The monitoring data item name display section 51 displays a type of monitoring data that undergoes normality determination by the control device 100, that is, an item name of the monitoring data. When the control device 100 determines whether the monitoring data is normal, the monitoring data to undergo the determination is selectable. The monitoring data item name display section 51 of the monitoring data determination screen 50 can display the selected monitoring data item.

The reference value input section 52 is a section for inputting a reference value of monitoring data used for determining whether the monitoring data is normal. The reference value input section 52 is a section that can be used to input the reference value for each item of monitoring data using the input unit 160. When the user has input the reference value to the reference value input section 52, the reference value acquisition module 112 included in the processing unit 110 of the control device 100 acquires the reference value input by the user and stores the acquired value in the storage unit 140.

The allowable value input section 53 is a section that is used to input an allowable value with respect to the reference value of the monitoring data input to the reference value input section 52, that is, inputting a tolerable range of the reference value. The allowable value input section 53 is a section that can be used to input an allowable value for the reference value for each monitoring data using the input unit 160. When the user has input the allowable value in the allowable value input section 53, the allowable value acquisition module 113 included in the processing unit 110 of the control device 100 acquires the allowable value input by the user and stores the acquired value in the storage unit 140.

The alarm selector 54 is a portion that is used to select as to whether to enable or disable an alarm that notifies the user that the monitoring data exceeds an allowable value when the monitoring data exceeds the allowable value. The alarm selector 54 can be used to select whether to enable or disable the alarm for each monitoring data by using the input unit 160.

### Determination Control as to Whether Monitoring Data Satisfies Predetermined Value

Next, the following will describe a flow of control at monitoring the state of operation of the injection molding machine 1 while determining whether the monitoring data satisfies a predetermined value during forming of the molded article by the injection molding machine 1.

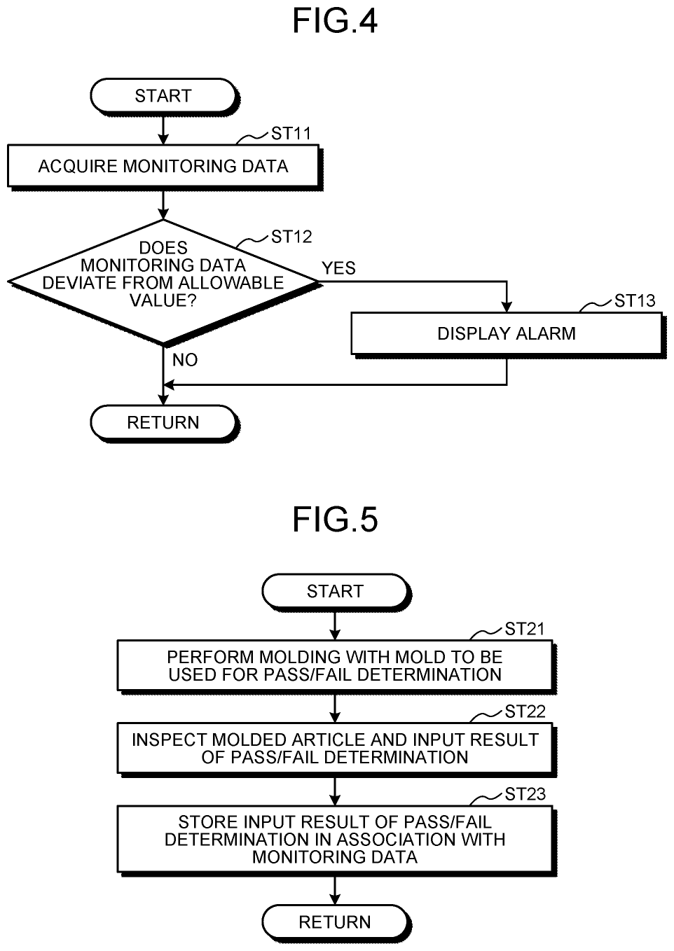

FIG. 4 is a flowchart illustrating a flow of control at determination control as to whether monitoring data satisfies a predetermined value. In the control of determining whether the monitoring data satisfies a predetermined value, monitoring data is acquired from each sensor provided in the injection molding machine 1 while the molded article is formed by the injection molding machine 1 (step ST11). The monitoring data is acquired by the monitoring data acquisition module 111 included in the processing unit 110 of the control device 100.

After acquisition of the monitoring data, it is determined whether the acquired monitoring data deviates from an allowable value (step ST12). The determination as to whether the monitoring data deviates from the allowable value is made by the monitoring data determination module 114 included in the processing unit 110 of the control device 100. The monitoring data determination module 114 determines whether the monitoring data acquired by the monitoring data acquisition module 111 deviates from a range of allowable values centered on the reference value of the monitoring data, or whether the monitoring data falls within the range of allowable values. The reference value in this example is a reference value acquired by the reference value acquisition module 112 as a result of user input of the reference value into the reference value input section 52 of the monitoring data determination screen 50, while the allowable value is an allowable value acquired by the allowable value acquisition module 113 as a result of user input of the allowable value into the allowable value input section 53 of the monitoring data determination screen 50.

When the monitoring data determination module 114 has determined that the monitoring data acquired by the monitoring data acquisition module 111 does not deviate from the allowable value (step ST12: No determination), forming of the molded article by the injection molding machine 1 is continued.

In contrast, when the monitoring data determination module 114 has determined that the monitoring data acquired by the monitoring data acquisition module 111 deviates from the allowable value (step ST12: Yes determination), an alarm is displayed (step ST13). For example, regarding the alarm display, the control device 100 controls to display the alarm on the display unit 170. Regarding details of the alarm, when the monitoring data selected to enable the alarm by the alarm selector 54 of the monitoring data determination screen 50 deviates from an allowable value, an alarm indicating that the monitoring data deviates from the allowed value is displayed on the display unit 170.

When the injection molding machine 1 includes a take-out robot (not illustrated) for taking out the defective article, or a chute (not illustrated), and when it is determined that the monitoring data deviates from the allowable value, the molded article determined as the defective article is distributed to a storage location for the defective article by the take-out robot or the chute.

In forming molded articles by the injection molding machine 1, molding is performed while repeating these steps to determine whether the monitoring data satisfies a predetermined value.

Furthermore, the pass/fail determination system 200 of the injection molding machine 1 according to this example can determine whether a defective article has occurred in the molded articles based on the monitoring data in addition to determining whether the monitoring data satisfies a predetermined value at the time of forming the molded article by the injection molding machine 1. Next, the following will describe a method of monitoring an operation state of the injection molding machine 1 by determining whether a defective article has occurred in molded articles formed by the injection molding machine 1 based on monitoring data.

### Generation of Basic Data

A first step in determining whether a defective article has occurred in the molded articles based on the monitoring data is to generate basic data to be a basis of the determination method.

FIG. 5 is a flowchart illustrating a procedure of generating basic data. A first step in generating basic data is to perform molding using the injection molding machine 1 with a mold to be used to perform pass/fail determination of a molded article (step ST21). The molding by the injection molding machine 1 in this example is not molding of an actual product but molding for specifically generating basic data.

After the molding is performed, the molded article is inspected for each shot performed by the injection molding machine 1, and the result of the pass/fail determination is input to the control device 100 using the input unit 160 (step ST22). Inspection of the molded article is conducted as user's manual determination as to whether the molded article is a non-defective article or a defective article. That is, the inspection of the molded article is performed as user's visual determination as to whether the molded article is a non-defective article or a defective article.

At the time of input to the control device 100, for example, a screen for inputting whether the molded article is a non-defective article or a defective article is displayed on the display unit 170, and a determination result as to whether the molded article is a non-defective article is input to the input screen of the display unit 170 for each shot by the injection molding machine 1 using the input unit 160. At this time, when the molded article is a defective article, the defect type of the defective article, that is, the defect name is input together with the result.

When the molded article pass/fail determination result has been input to the control device 100, the control device 100 stores the input pass/fail determination result in the storage unit 140 in association with the monitoring data (step ST23). Specifically, the control device 100 uses the basic data generation module 121 included in the processing unit 110 to associate the input pass/fail determination result of the molded article with the monitoring data, which is data at formation of the molded article by the injection molding machine 1 and obtained by the monitoring data acquisition module 111 included in the processing unit 110. At that time, the basic data generation module 121 also associates the defect name regarding the defective article. The basic data generation module 121 stores the data associated in this manner in the storage unit 140 as basic data.

In acquisition of the basic data generated as described above, when a predetermined number or pieces of data or more has been obtained in each of the non-defective article shot monitoring data and the defective article shot monitoring data, the data acquisition of the basic data is finished.

After the basic data is generated like this, the next step is to set parameters used for pass/fail determination of the molded article to be performed when the molded article is formed as a product. A procedure of setting parameters to be used for pass/fail determination of a molded article will be described.

### Setting Parameter Used for Pass/Fail Determination of Molded Article

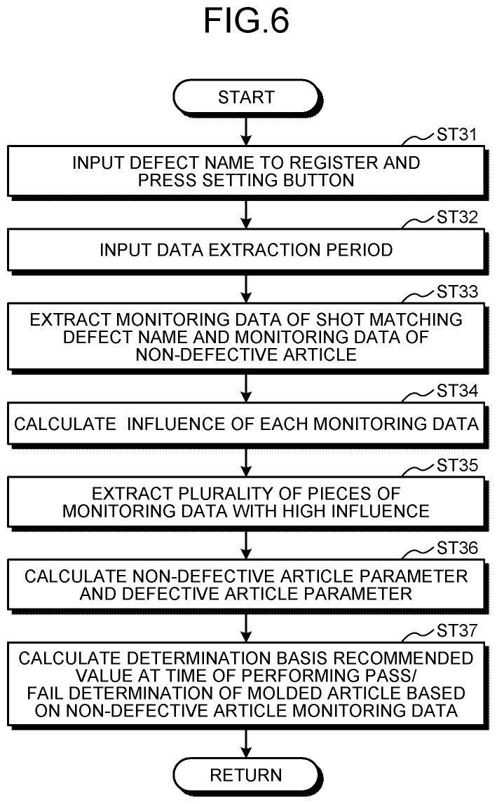

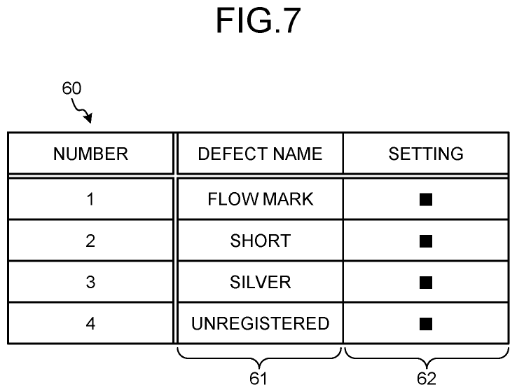

FIG. 6 is a flowchart illustrating a procedure of setting a parameter used in pass/fail determination of a molded article. FIG. 7 is a schematic diagram of a pass/fail determination setting main screen 60 used at setting of a parameter for pass/fail determination. After the basic data is generated, the parameter to be used for the pass/fail determination of the molded article will be set, and at this time a pass/fail determination setting main screen 60 as illustrated in FIG. 7 is first displayed on the display unit 170, and parameter setting is to be performed by using the pass/fail determination setting main screen 60. With an operation on the control device 100 using the input unit 160, the pass/fail determination setting main screen 60 calls a program related to the pass/fail determination setting main screen 60 and displays the program on the display unit 170.

The pass/fail determination setting main screen 60 includes a defect name input section 61 used to input a defect name of a defective article and a setting button 62 corresponding to the defect name input section 61. The pass/fail determination setting main screen 60 includes a plurality of the defect name input sections 61, with the setting button 62 set for each of the defect name input sections 61. In the pass/fail determination setting main screen 60, a different number is displayed to be assigned to each of the defect name input sections 61.

At the time of setting of the parameter used for the pass/fail determination of the molded article, the pass/fail determination setting main screen 60 is displayed on the display unit 170, the defect name to be registered is input to the defect name input section 61 of the pass/fail determination setting main screen 60 using the input unit 160, and then, the setting button 62 corresponding to the defect name input section 61 to which the defect name has been input is pressed (step ST31).

### Pass/Fail Determination Setting Sub-Screen 70

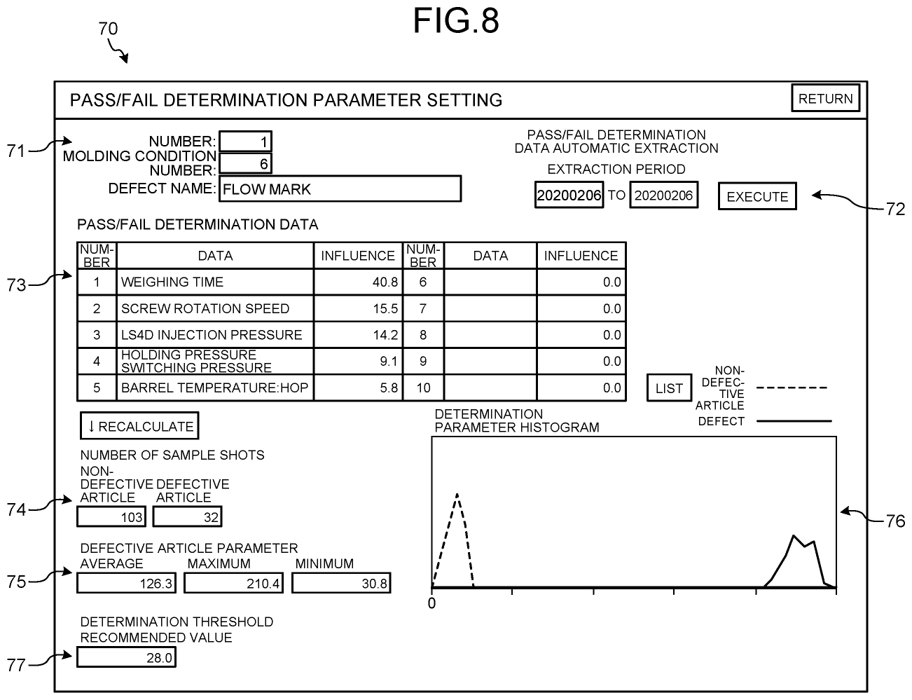

FIG. 8 is a schematic diagram of the pass/fail determination setting sub-screen 70. When the setting button 62 is pressed on the pass/fail determination setting main screen 60, the control device 100 displays a pass/fail determination setting sub-screen 70 corresponding to the pressed setting button 62 on the display unit 170. For example, as illustrated in FIG. 8, the pass/fail determination setting sub-screen 70 includes a defect information display section 71, an extraction period input section 72, a pass/fail determination data display section 73, a sample shot number display section 74, a defective article parameter display section 75, a determination parameter histogram display section 76, and a determination basis recommended value display section 77.

The defect information display section 71 is a section that displays information regarding the defect name input in the defect name input section 61 corresponding to the setting button 62 pressed on the pass/fail determination setting main screen 60. The defect information display section 71 displays information such as the defect name input to the defect name input section 61, the number assigned to the defect name input section 61, and the molding condition number representing the type of mold used at generation of the basic data.

The extraction period input section 72 is a section for inputting a period of monitoring data extracted by the monitoring data extraction module 122 from among the monitoring data included in the generated basic data. That is, the extraction period input section 72 is a section for inputting which period of monitoring data is to be extracted, as the monitoring data to be extracted by the monitoring data extraction module 122.

The pass/fail determination data display section 73 is a section that displays, among the monitoring data extracted by the monitoring data extraction module 122, monitoring data to be used for determination of a defect type, which is to be a defect name corresponding to the setting button 62 pressed on the pass/fail determination setting main screen 60.

The sample shot number display section 74 is a section that displays the number of shots in the injection molding machine 1 at the time of generation of the basic data. Specifically, the sample shot number display section 74 is a section that displays the number of non-defective article shots and the number of defective article shots in the monitoring data extracted by the monitoring data extraction module 122.

The defective article parameter display section 75 is a section that displays the defective article parameter, which is a determination parameter for the monitoring data extracted by the monitoring data extraction module 122, that is, defective article parameter of the monitoring data at molding of the defective article of the defect name set by pressing the setting button 62 on the pass/fail determination setting main screen 60 in the basic data. The determination parameter here is a value of the square of the Mahalanobis distance obtained by applying the known MT method. The defective article parameter display section 75 displays an average defective article parameter, a maximum defective article parameter, and a minimum defective article parameter of the defective article monitoring data in the monitoring data extracted by the monitoring data extraction module 122 from the basic data.

The determination parameter histogram display section 76 is a section that displays, as a histogram, individual determination parameters with respect to the monitoring data extracted by the monitoring data extraction module 122, specifically for the non-defective article monitoring data and the defective article monitoring data extracted by the monitoring data extraction module 122 from the basic data. That is, the determination parameter histogram display section 76 displays the non-defective article parameters and the defective article parameters calculated by the determination parameter calculation module 124.

The determination basis recommended value display section 77 is a section that displays a recommended value of a determination threshold when molding is performed by the injection molding machine 1, when a determination as to whether the molded article is a defective article having a defective name set by pressing the setting button 62 on the pass/fail determination setting main screen 60 is performed based on the determination parameter calculated from the monitoring data.

When the user presses the setting button 62 on the pass/fail determination setting main screen 60 (refer to FIG. 7) to display the pass/fail determination setting sub-screen 70 (refer to FIG. 8) corresponding to the setting button 62 on the display unit 170, the user inputs the data extraction period using the pass/fail determination setting sub-screen 70 (step ST32). The data extraction period is input to the extraction period input section 72 of the pass/fail determination setting sub-screen 70 using the input unit 160.

After inputting the data extraction period, the control device 100 extracts, from the basic data, monitoring data of a shot that matches the defect name indicated by user's pressing of the setting button 62 on the pass/fail determination setting main screen 60 and monitoring data of a non-defective article shot (step ST33). This extraction is performed by the monitoring data extraction module 122 included in the processing unit 110 of the control device 100. That is, the monitoring data extraction module 122 extracts, from the basic data, the monitoring data at the time of molding of the defective article corresponding to the defect type of the defect name indicated by user's pressing of the setting button 62 on the pass/fail determination setting main screen 60, that is, extracts the defective article monitoring data. Further, the monitoring data extraction module 122 extracts, from the basic data, the non-defective article monitoring data, which is the same type of monitoring data as the defective article monitoring data and is the monitoring data at the time of molding the non-defective article.

After extraction of the monitoring data is extracted from the basic data by the monitoring data extraction module 122, calculation of an influence of each monitoring data is performed (step ST34). The influence in this example is a degree of influence of the monitoring data extracted by the monitoring data extraction module 122 on the defect type of the defect name indicated by user's pressing of the setting button 62 on the pass/fail determination setting main screen 60. That is, the influence in this example is an index indicating how much each piece of monitoring data extracted by the monitoring data extraction module 122 contributes to the occurrence of defect regarding the defect type selected on the pass/fail determination setting main screen 60 by the user.

The calculation of the influence is performed by the high-influence monitoring data extraction module 123 included in the processing unit 110 of the control device 100. The high-influence monitoring data extraction module 123 calculates the influence based on the plurality of pieces of non-defective article monitoring data and the defective article monitoring data extracted by the monitoring data extraction module 122, using Formula (1). The influence is calculated for each type of monitoring data.

$$( 1 )$$

$$Influence = ( average value of non - defective article monitoring data - average value of defective article monitoring data ) / standard deviation σ of non - defective article monitoring data$$

After calculation of the influence of the monitoring data, next, a plurality of pieces of monitoring data with high influence is extracted (step ST35). Extraction of monitoring data of high influence is to be performed continuously by the high-influence monitoring data extraction module 123, which has calculated the influence. The high-influence monitoring data extraction module 123 extracts a plurality of pieces of monitoring data in order from the one having the highest influence on the defect type of the defective article selected on the pass/fail determination setting main screen 60 by the user, among the plurality of pieces of monitoring data extracted by the monitoring data extraction module 122. That is, the high-influence monitoring data extraction module 123 extracts a plurality of monitoring data in descending order of the influence calculated by the above Formula (1).

In this example, the number of pieces of monitoring data extracted by the high-influence monitoring data extraction module 123 in descending order of influence is optional.

Based on the calculated influence, the user can optionally select the number of pieces of monitoring data extracted by the high-influence monitoring data extraction module 123 in a range of 2 to 10, for example. Therefore, for example, when the number of pieces of monitoring data extracted by the high-influence monitoring data extraction module 123 is set to 3, the high-influence monitoring data extraction module 123 extracts three pieces of monitoring data in order from the highest influence on the defect type.

The number of pieces of monitoring data to be extracted by the high-influence monitoring data extraction module 123 may vary in some examples. For example, the number of pieces of monitoring data may be small in the defect type in which causal monitoring data is known to some extent, and the number of pieces of monitoring data may be large in the defect type in which causal monitoring data is unknown. The number of monitoring data extracted by the high-influence monitoring data extraction module 123 can be set to any number by the user according to a defect type or the like.

### Grouping of Monitoring Data

In addition, when extracting monitoring data having a high influence on a defect type, the high-influence monitoring data extraction module 123 groups pieces of monitoring data having high correlation coefficient as a same group, and extracts only one piece of monitoring data having the highest influence from the same group.

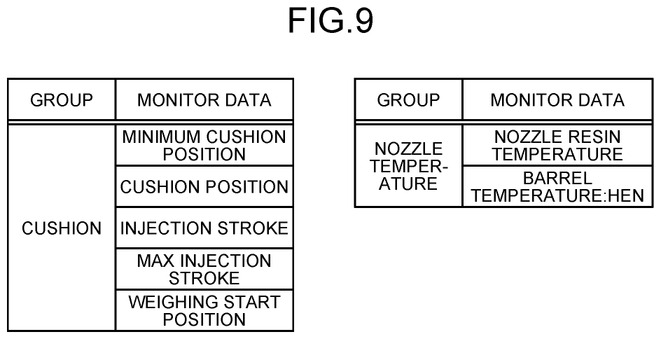

FIG. 9 is a diagram illustrating grouping of monitoring data. Grouping of the monitoring data is performed such that, a correlation coefficient between different types of monitoring data is calculated, and a plurality of pieces of monitoring data having the high correlation coefficient is grouped into one group as illustrated in FIG. 9, for example. Grouping of the monitoring data is performed in advance and information regarding the grouping is stored in the storage unit 140. Although FIG. 9 illustrates an example of using two groups, the number of groups to be set and the number of pieces of monitoring data in one group are appropriately set according to the correlation coefficient between individual pieces of monitoring data.

When extracting monitoring data having a high influence on a defect type, the high-influence monitoring data extraction module 123 refers to grouping data stored in the storage unit 140, and extracts one piece of monitoring data having the highest influence from one group to achieve extraction of a plurality of set number of pieces of monitoring data. The monitoring data extracted in this manner by the high-influence monitoring data extraction module 123 is displayed together with the calculated influence on the pass/fail determination data display section 73 of the pass/fail determination setting sub-screen 70.

Next, a non-defective article parameter being a determination parameter of the non-defective article monitoring data and a defective article parameter being a determination parameter of the defective article monitoring data are individually calculated in the monitoring data extracted by the monitoring data extraction module 122 (step ST36). The non-defective article parameter and the defective article parameter are calculated by the determination parameter calculation module 124 included in the processing unit 110 of the control device 100.

In this example, the non-defective article parameter and the defective article parameter are calculated from the non-defective article monitoring data and the defective article monitoring data in the high-influence monitoring data, which is the monitoring data extracted by the high-influence monitoring data extraction module 123.

When the number of pieces of high-influence monitoring data to be extracted by the high-influence monitoring data extraction module 123 is three, for example, the determination parameter calculation module 124 calculates the non-defective article parameter and the defective article parameter using the non-defective article monitoring data and the defective article monitoring data of each of the three pieces of high-influence monitoring data by Formula (2).

$${MD}^{2} = ( a - \overline{a} , b - \overline{b} , c - \overline{c} ) {( \begin{matrix}{s}_{a}^{2} & {s}_{ab} & {s}_{ac} \\ {s}_{ab} & {s}_{b}^{2} & {s}_{bc} \\ {s}_{ac} & {s}_{bc} & {s}_{c}^{2}\end{matrix} )}^{- 1} ( \begin{matrix}a - \overline{a} \\ b - \overline{b} \\ c - \overline{c}\end{matrix} ) / 3 \qquad ( 2 )$$

In Formula (2), MD² represents a determination parameter being a parameter to be used when pass/fail determination of the molded article is performed based on the monitoring data, and corresponds to both the non-defective article parameter and the defective article parameter. In this example, the parameter MD² calculated by Formula (2) in this manner is treated as a non-defective article parameter or a defective article parameter, that is, a determination parameter of the monitoring data. In addition, in Formula (2), a, b, and c represent monitoring data, being monitoring data having a higher influence on a defect type in the order of a, b, and c, and S represents a sum of squares. In Formula (2), the non-defective article parameter and the defective article parameter are calculated using the three pieces of high-influence monitoring data, and thus, the number of pieces of monitoring data is three, namely, a, b, and c. However, the number of pieces of monitoring data in Formula (2) increases or decreases in accordance with the number of pieces of high-influence monitoring data extracted by the high-influence monitoring data extraction module 123.

In addition, the determination parameter calculation module 124 calculates a defective article parameter from the defective article monitoring data extracted by the monitoring data extraction module 122 even for monitoring data other than the high-influence monitoring data. These defective article parameters calculated by the determination parameter calculation module 124 are displayed on the defective article parameter display section 75 of the pass/fail determination setting sub-screen 70.

Next, a determination basis recommended value at the time of performing the pass/fail determination of the molded article is calculated based on the non-defective article monitoring data (step ST37). The recommended value calculation module 126 included in the processing unit 110 of the control device 100 calculates the determination basis recommended value. In this example, the recommended value calculation module 126 calculates the determination basis recommended value using the non-defective article parameter calculated based on the non-defective article monitoring data and the defective article parameter calculated based on the defective article monitoring data by Formula (3).

$$( 3 )$$

$$Determination basis recommended value = \frac{( \overline{{MD}^{2}} + 3 σ ) + ( \overline{{MD}^{′2}} - 3 {σ}^{′} )}{2}$$

In Formula (3), MD² is a non-defective article parameter, and MD′² is a defective article parameter. In Formula (3), σ is the standard deviation of the non-defective article parameter, and σ′ is the standard deviation of the defective article parameter.

The determination basis recommended value calculated by the recommended value calculation module 126 is displayed on the determination basis recommended value display section 77 of the pass/fail determination setting sub-screen 70.

In this example, by setting the parameter for the pass/fail determination of the molded article by the pass/fail determination setting main screen 60 and the pass/fail determination setting sub-screen 70 and then forming the molded article, it is possible to determine, based on the monitoring data, whether a defective article has occurred in the molded articles formed by the injection molding machine 1.

### Pass/Fail Determination Screen 80

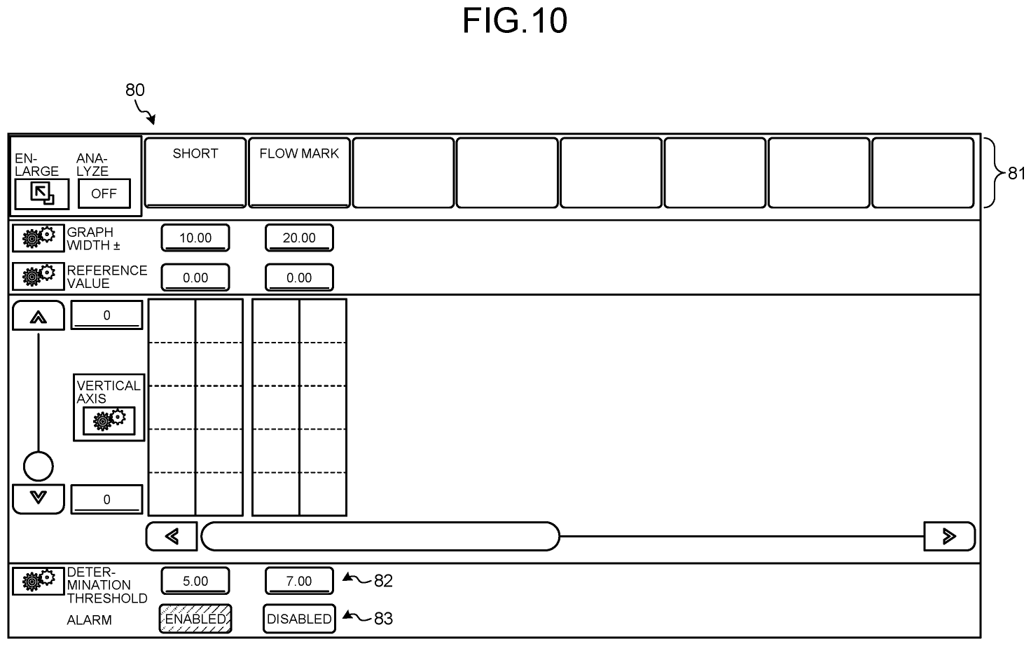

Next, the following will describe a pass/fail determination screen 80 that is to be displayed on the display unit 170 and that is used for control of determining, based on monitoring data, whether a defective article has occurred in molded articles formed by the injection molding machine 1. FIG. 10 is a diagram illustrating the pass/fail determination screen 80. The control device 100 determines whether a defective article has occurred in the molded article formed by the injection molding machine 1 while displaying the pass/fail determination screen 80 as illustrated in FIG. 10 on the display unit 170. The pass/fail determination screen 80 illustrated in FIG. 10 includes a defect name display section 81, a determination threshold input section 82, and an alarm selector 83.

The defect name display section 81 displays a name of a defect type of a defective article, that is, the defect name during execution of the pass/fail determination of the molded article formed by the injection molding machine 1, on the control device 100. When the control device 100 determines whether the molded article is a defective article, a defect name to be determined can be selected, and the defect name display section 81 of the pass/fail determination screen 80 can display the selected defect name.

The determination threshold input section 82 is a section for inputting a determination threshold, which is a threshold for a determination parameter, at the time of determination as to whether the molded article is a defective article based on the determination parameter of the monitoring data acquired at the time of forming the molded article. The determination threshold input section 82 is a section on which a determination threshold can be input for each defect name using the input unit 160. The determination threshold input section 82 has a determination threshold default value input as a determination basis recommended value calculated by the recommended value calculation module 126. Based on this, the user can appropriately change the determination basis recommended value according to the molded article, the defect type or the like, to set a value suitable for the molded article, the defect type or the like, as the determination threshold.

The alarm selector 83 is a section used for selecting whether to enable or disable an alarm that notifies the user that the determination parameter of the monitoring data exceeds a determination threshold when the determination parameter of the monitoring data exceeds the determination threshold. The alarm selector 83 can be used to select whether to enable or disable the alarm for each defect name using the input unit 160.

### Control of Determination as to Whether Defective Article has Occurred in Molded Articles

By setting parameters for performing the pass/fail determination on the molded article using the pass/fail determination setting main screen 60 and the pass/fail determination setting sub-screen 70, it is possible to perform control to determine whether a defective article has occurred in the molded article after the determination threshold is determined. Next, the following will describe the control of determining whether a defective article has occurred in a molded article formed by the injection molding machine 1 based on monitoring data.

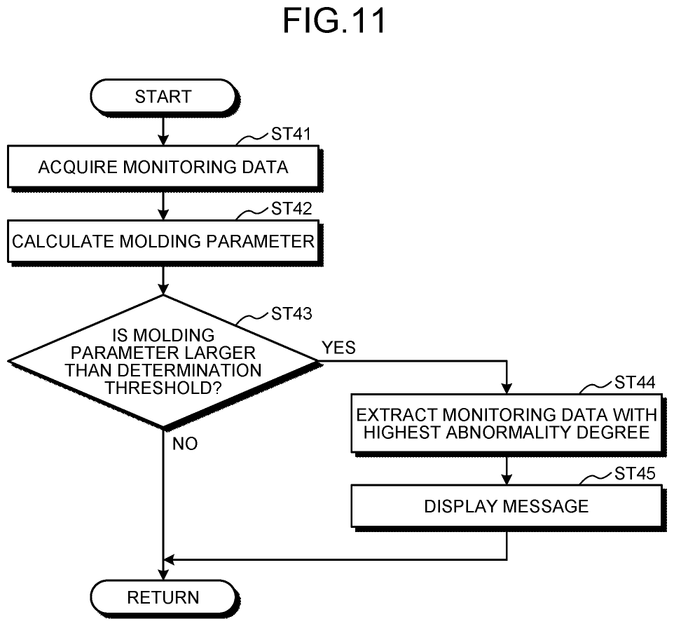

FIG. 11 is a flowchart illustrating a flow of control when control is performed to determine whether a defective article has occurred in molded articles based on monitoring data. In the control of performing pass/fail determination of a molded article, monitoring data is acquired from each sensor provided in the injection molding machine 1 during forming of the molded article by the injection molding machine 1 (step ST41). The monitoring data is acquired by the monitoring data acquisition module 111 included in the processing unit 110 of the control device 100. The monitoring data acquisition module 111 acquires monitoring data for each shot by the injection molding machine 1 and updates the data.

After acquisition of the monitoring data, the molding parameter is calculated (step ST42). The molding parameter is calculated by the molding parameter calculation module 125 included in the processing unit 110 of the control device 100. The molding parameter calculation module 125 calculates the molding parameter by calculating a determination parameter of the same type of monitoring data as the high-influence monitoring data extracted by the high-influence monitoring data extraction module 123 in the monitoring data acquired by the monitoring data acquisition module 111. That is, the molding parameter calculation module 125 calculates the molding parameter by calculating a determination parameter of the same type of monitoring data as the high-influence monitoring data for the plurality of pieces of monitoring data extracted from the basic data by the monitoring data extraction module 122.

Since the high-influence monitoring data is calculated for each defect type, that is, for each defect name, the molding parameter calculated from the monitoring data of the same type as the high-influence monitoring data is also calculated for each defect name. The molding parameter is calculated by applying the MT method as in obtaining the determination parameter of the monitoring data by the determination parameter calculation module 124. With this method, the molding parameter is calculated by obtaining the square value of the Mahalanobis distance of the monitoring data of the same type as the high-influence monitoring data with respect to a plurality of pieces of monitoring data extracted from the basic data. Regarding the molding parameter, monitoring data is acquired by the monitoring data acquisition module 111, and the molding parameter is calculated at the timing when the data is updated.

After calculation of the molding parameter, next, it is determined whether the molding parameter is larger than a determination threshold (step ST43). This determination is performed by the pass/fail determination module 127 included in the processing unit 110 of the control device 100. The pass/fail determination module 127 compares the molding parameter calculated by the molding parameter calculation module 125 with a determination threshold that is a threshold for the molding parameter, and determines whether a defective article has occurred in the molded articles formed by the injection molding machine 1.

The determination threshold used for this determination is a value set by the determination threshold input section 82 on the pass/fail determination screen 80. The determination threshold has been set as a determination basis recommended value calculated by the recommended value calculation module 126 or a value set by the user based on the determination basis recommended value. The pass/fail determination module 127 compares the determination threshold set in this manner with the molding parameter calculated by the molding parameter calculation module 125 for each defect name, and determines whether the molding parameter is larger than the determination threshold for each defect name.

When it is determined by the pass/fail determination module 127 that the molding parameter calculated by the molding parameter calculation module 125 is not larger than the determination threshold (step ST43: No determination), forming of the molded article by the injection molding machine 1 is continued.

In contrast, when it is determined by the pass/fail determination module 127 that the molding parameter calculated by the molding parameter calculation module 125 is larger than the determination threshold (step ST43: Yes determination), monitoring data having the highest abnormality degree is extracted (step ST44). The monitoring data having the highest abnormality degree is extracted by the abnormal data extraction module 128 included in the processing unit 110 of the control device 100. The determination as to whether the molding parameter is larger than the determination threshold is performed for each defect name. Therefore, the abnormal data extraction module 128 extracts monitoring data having the highest abnormality degree in the defect name for which it is determined that the molding parameter is larger than the determination threshold.

The abnormal data extraction module 128 extracts, as monitoring data of the highest abnormality degree, monitoring data having the largest deviation from the non-defective article monitoring data in the high-influence monitoring data among a plurality of pieces of monitoring data of the same type as the plurality of pieces of high-influence monitoring data in the monitoring data acquired by the monitoring data acquisition module 111. Specifically, the abnormal data extraction module 128 calculates the deviation degree by Formula (4), and extracts the monitoring data having the largest deviation degree as the monitoring data having the highest abnormality degree.

$$( 4 )$$

$$Deviation degree = \vert ( average value of non - defective article monitoring data - monitoring data of corresponding shot ) / ( standard deviation σ of non - defective article monitoring data ) \vert$$

The abnormal data extraction module 128 performs calculation using the above Formula (4) for each of a plurality of pieces of monitoring data of the same type as the plurality of pieces of high-influence monitoring data to calculate the deviation degree for each piece of monitoring data, and then, extracts the monitoring data having the highest abnormality degree.

When the monitoring data having the highest abnormality degree is extracted, a message is displayed (step ST45). Display of the message is performed by the control device 100 on the display unit 170, for example. When the alarm selector 83 of the pass/fail determination screen 80 has determined that the molding parameter of the defect name for which enabling of the alarm has been selected is larger than the determination threshold, the message notifying the monitoring data having the highest abnormality degree, as well as notifying the defect name, is displayed on the display unit 170. That is, a message indicating that a defect having a defect name has occurred and that a value of monitoring data having the highest abnormality degree is abnormal is displayed on the display unit 170.

When a message is displayed on the display unit 170, the injection molding machine 1 is adjusted so that the value of the displayed monitoring data becomes a normal value, making it possible to solve the issue of the defect type of the defect name displayed on the display unit 170.

There may be a situation where the injection molding machine 1 includes a take-out robot (not illustrated) or a chute (not illustrated) that takes out the defective article. In this example, when it is determined that the molding parameter is larger than the determination threshold, the molded article formed by the shot may be distributed to a storage location for the defective article by the take-out robot or the chute.

### Effects of Example

Before forming a molded article as a product, the pass/fail determination system 200 of the injection molding machine 1 according to the above example extracts a plurality of pieces of non-defective article monitoring data and a plurality of pieces of defective article monitoring data from basic data associating the determination result as to whether the molded article is a non-defective article or a defective article with the monitoring data, and further extracts high-influence monitoring data that is monitoring data having a high influence on a defect type of the defective article from among the extracted monitoring data. Thereafter, when a molded article to be a product is formed by the injection molding machine 1, a molding parameter that is a determination parameter of monitoring data of the same type as the high-influence monitoring data is calculated. The calculated molding parameter is compared with a determination threshold that is a threshold for the molding parameter, thereby determining whether a defective article has occurred in the molded articles formed by the injection molding machine 1.

With this configuration, even when any of the monitoring data causes an interaction with the molded article formed by the injection molding machine 1, the pass/fail determination of the molded article is performed based on the high-influence monitoring data extracted in advance, making it possible to determine the occurrence of a defective article with high accuracy at the time of occurrence of the defective article. In addition, by performing the pass/fail determination of the molded article based on the high-influence monitoring data extracted in advance, monitoring data being a factor of the generation of a defective article can be specified at the time of occurrence of the defective article in the molded articles. This makes it possible to improve the accuracy of the pass/fail determination, and more reliably specify the cause of the defect.

The monitoring data extraction module 122 extracts non-defective article monitoring data and defective article monitoring data from the basic data for each defect type, while the molding parameter calculation module 125 calculates the molding parameter for each defect type. In addition, the pass/fail determination module 127 determines whether a defective article has occurred in the molded articles for each defect type. With this configuration, at the time of determination that the molded article is a defective article, it is possible to perform the determination by specifying a defective type of the defective article, that is, a defective name, making it possible to specify, for each defective name, monitoring data indicating a factor of occurrence of the defective article. This makes it possible to further improve the accuracy of the pass/fail determination, and more reliably specify the cause of the defect.

There is also provided the abnormal data extraction module 128 that extracts the monitoring data having the highest abnormality degree when it is determined that the defective article occurs in the molded articles. Therefore, the monitoring data indicating a factor of the occurrence of the defective article can more reliably be specified when the defective article occurs in the molded articles. This makes it possible to more reliably specify the cause of the defect when the defective article occurs in the molded articles.

Furthermore, during forming of a molded article by the injection molding machine 1, pass/fail determination of the molded article can be performed for each defect type, and monitoring data having a high abnormality degree can be specified for each defect type. Therefore, when the molding condition in the injection molding machine 1 is adjusted to solve the molding defect, the operation can be performed easily. As a result, even when a defective article occurs in the molded articles, the molding defect can be more reliably solved, making it possible to facilitate suppressing the occurrence of defective articles.

In addition, there is also provided the recommended value calculation module 126 that calculates a determination basis recommended value used in determining whether a defective article has occurred in the molded article, based on the non-defective article monitoring data. The pass/fail determination module 127 uses, as a determination threshold, the determination basis recommended value calculated by the recommended value calculation module 126, and thus can more appropriately determine whether a defective article has occurred in the molded articles formed by the injection molding machine 1. This makes it possible to further improve the accuracy of the pass/fail determination, and more reliably specify the cause of the defect.

In addition, the monitoring data is set by being grouped in advance such that pieces of monitoring data having a high correlation coefficient belong to the same group, and the high-influence monitoring data extraction module 123 extracts only one piece of monitoring data having the highest influence from the same group. This makes it possible to suppress extraction of pieces of monitoring data having a high correlation coefficient as high-influence monitoring data. This makes it possible to suppress, when the recommended value calculation module 126 calculates the determination basis recommended value, occurrence of deviation in the monitoring data to be a basis of calculating the determination basis recommended value due to extraction of pieces of monitoring data having high correlation coefficients as the high-influence monitoring data. Accordingly, it is possible to suppress, at the time of pass/fail determination of the molded article, the determination by referring only to the pieces of monitoring data having a high correlation coefficient, leading to achievement of monitoring of the monitoring data indicating the cause of the defective article from various perspectives. This makes it possible to further improve the accuracy of the pass/fail determination, and more reliably specify the cause of the defect.

### Modification

In the example described above, the basic data is generated by user's visual inspection of the molded article in the procedure of generating the basic data and by user's input of whether the molded article is a non-defective article or a defective article to the control device 100. Alternatively, the control device 100 may automatically generate the basic data when molding is performed by the injection molding machine 1.

For example, the injection molding machine 1 may include an image capturing unit such as a camera that captures an image of the molded article and converts the image into image data. Furthermore, the molded article may be imaged by the image capturing unit in the step of generating basic data, and the image data of the imaged molded article may be analyzed to determine whether the molded article is a non-defective article or a defective article. In this manner, by determining whether the molded article is a non-defective article or a defective article based on the image data captured by the image capturing unit and generating the basic data by associating the determination result with the monitoring data, it is possible to generate the basic data easily.

In the example described above, the determination basis recommended value is calculated by Formula (3) using the non-defective article parameter calculated based on the non-defective article monitoring data and the defective article parameter calculated based on the defective article monitoring data. Alternatively, the determination basis recommended value may be calculated by a method other than Formula (3). For example, the determination basis recommended value may be calculated by Formula (5) without using the defective article parameter.

$$Determination basis recommended value = \overline{{MD}^{2}} + 3 σ \qquad ( 5 )$$

The method of calculating the determination basis recommended value may preferably be appropriately determined according to the defect type of the defective article, or conditions such as whether the molded article deviated from the non-defective article is to be allowed.

In the example described above, the monitoring data is detected by the sensors provided in individual portions of the injection molding machine 1. However, the number of sensors to detect the monitoring data during the operation of the injection molding machine 1 may be increased or decreased as necessary. In this manner, when the number of sensors to be disposed in the injection molding machine 1 is changed, it is preferable to set the grouping of the monitoring data every time the number of sensors is changed. That is, when the number of sensors disposed in the injection molding machine 1 is changed, the correlation coefficient of the monitoring data detected by each sensor is calculated for each monitoring data, and based on the calculated correlation coefficient, grouping of the monitoring data is performed such that the monitoring data with high correlation coefficients are grouped to be in the same group. For example, regarding the monitoring data detected by each sensor, monitoring data having a correlation coefficient of 0.5 or more are determined to have a correlation and set to belong to a same group.

This makes it possible to suppress, when the number of sensors to be disposed in the injection molding machine 1 has been changed, occurrence of deviation in the monitoring data to be a basis of calculating the determination basis recommended value due to extraction of pieces of monitoring data having high correlation coefficients as the high-influence monitoring data. As a result, even when the number of sensors for detecting the monitoring data has been changed, it is possible to improve the accuracy of the pass/fail determination and specify the cause of the defect further reliably.

This application is a national stage application of International Application No. PCT/JP2022/027867, filed on Jul. 15, 2022, which designates the United States, incorporated herein by reference, and which is based upon and claims the benefit of priority from Japanese Patent Application No. 2021-120631, filed on Jul. 21, 2021, the subject matter of which is incorporated herein by reference.

1.-4. (canceled)

5. An injection molding machine pass/fail determination system comprising:
a monitoring data extraction module configured to extract, from basic data in which a determination result as to whether a molded article formed by an injection molding machine is a non-defective article or a defective article is associated with monitoring data of the injection molding machine at a time of forming the molded article, a plurality of pieces of non-defective article monitoring data and a plurality of pieces of defective article monitoring data, the plurality of pieces of non-defective article monitoring data being the monitoring data at a time of forming the non-defective article, and the plurality of pieces of defective article monitoring data being the monitoring data at a time of forming the defective article;
a high-influence monitoring data extraction module configured to extract a plurality of pieces of the monitoring data as high-influence monitoring data in descending order of influence on a defect type of the defective article among the plurality of pieces of the monitoring data extracted by the monitoring data extraction module;
a molding parameter calculation module configured to calculate a molding parameter, the molding parameter being a parameter to be used when pass/fail determination of the molded article during molding performed by the injection molding machine is performed based on the monitoring data of a same type as the high-influence monitoring data; and
a pass/fail determination module configured to compare the molding parameter calculated by the molding parameter calculation module with a determination threshold being a threshold for the molding parameter, and determine whether the defective article has occurred in the molded article formed by the injection molding machine.

6. The injection molding machine pass/fail determination system according to claim 5, wherein
the monitoring data extraction module is configured to extract the non-defective article monitoring data and the defective article monitoring data for each of defect types of the defective article,
the molding parameter calculation module is configured to calculate the molding parameter for each of the defect types, and
the pass/fail determination module is configured to determine whether the defective article has occurred in the molded article for each of the defect types.

7. The injection molding machine pass/fail determination system according to claim 5, further comprising
an abnormal data extraction module configured to extract the monitoring data having a highest abnormality degree when the pass/fail determination module has determined that the defective article has occurred in the molded article, wherein
the abnormal data extraction module is configured to extract, as the monitoring data having the highest abnormality degree, monitoring data having a largest deviation from the non-defective article monitoring data in the high-influence monitoring data, among a plurality of pieces of the monitoring data of the same type as a plurality of pieces of the high-influence monitoring data during molding performed by the injection molding machine.

8. The injection molding machine pass/fail determination system according to claim 5, further comprising
a recommended value calculation module configured to calculate a determination basis recommended value at the time of determining whether the defective article has occurred in the molded article based on the non-defective article monitoring data extracted by the monitoring data extraction module, wherein
the pass/fail determination module is configured to use the determination basis recommended value calculated by the recommended value calculation module, as the determination threshold.
